(19) United States
(12) Patent Application Publication
(10) Pub. No.: US 2015/0353031 A1
(43) Pub. Date: Dec. 10, 2015

(54) Electronic License Plate

(71) Applicant: Raul Cairo, Miami, FL (US)

(72) Inventor: Raul Cairo, Miami, FL (US)

(21) Appl. No.: 14/736,001

(22) Filed: Jun. 10, 2015

Related U.S. Application Data
(60) Provisional application No. 62/010,127, filed on Jun. 10, 2014.

(51) Int. Cl. B60R 13/10

(52) U.S. Cl. CPC B60R 13/105

(57) ABSTRACT

The present invention provides an electronic license plate configured to display relevant license plate information via a digital display. The electronic license plate includes a housing forming an interior volume configured to support a display assembly and a display in electric communication with the display assembly. The display assembly comprises a microprocessor having an input module and an activating module. The input module is configured to allow a user to input relevant license plate information. The activating module is configured to process the relevant license plate information and determine if the relevant license plate information is expired. The microprocessor is configured to transmit the relevant license plate information to be displayed on the display based on if the relevant license plate information is expired. The microprocessor is also configured to transmit an expired status or suspended status to the display when the relevant license plate information is expired.

### CROSS REFERENCE TO RELATED APPLICATION

This application claims the benefit of U.S. Provisional Application No. 62/010,127 filed on Jun. 10, 2014. The above identified patent application is herein incorporated by reference in its entirety to provide continuity of disclosure.

### FIELD OF THE INVENTION

The present invention relates to car accessories. Specifically, the present invention provides an electronic license plate that displays relevant license plate information, such as the date of registration and optionally the date of inspection, and displays an expired status or suspended status when the relevant license plate information is expired or suspended, respectively.

### BACKGROUND OF THE INVENTION

For many years, cars, trucks, and other vehicles have been required to have license plates, signifying proper registration of those vehicles with the appropriate governmental agency. The number of vehicles on the road has generally increased, where the appropriate governmental agencies are ill equipped to handle the workload for renewing registrations and conducting other services. Further, these governmental agencies are responsible for the issuance of license plates that are secured to a vehicle and display relevant licensing plate information that signify properly registration of the vehicle.

These license plates historically have been fabricated from metal, and thereby suffer from several disadvantages. One of the biggest disadvantages is that because the registration renewals are costly and reflected on the traditional license plates, these traditional license plates are often a target for theft. Another disadvantage is that these traditional license plates often clash with the aesthetics of modern styling used on newer cars. Further, outdated registrations are often hard to track, and therefore, allowed to expired, which may garner fines. In view of the foregoing, it should be appreciated that it would be desirable to provide a device that allows a user to electronically display relevant license plate information, wherein the device also deactivates when the relevant license plate information is expired.

Devices have been disclosed in the prior art that relate to electronic license plates. These include devices that have been patented and published in patent application publications. Some devices provide a license plate that can transmit the position of a vehicle via a satellite to allow police to track or monitor a vehicle. Other devices provide electronic registration plates that display the registration data of a vehicle and are powered by a solar housing. These devices, however, do not provide an electronic license plate comprising a display that is configured to display an expired or suspended status when the relevant license plate information is expired.

The present invention provides an electronic license plate configured to display relevant license plate information via a digital display. The electronic license plate includes a housing forming an interior volume configured to support a display assembly. A front face of the housing comprises a display configured to be in electric communication with the display assembly. The display assembly comprises a microprocessor having an input module and an activating module. The input module is configured to allow a user to input relevant license plate information. The activating module is configured to process the relevant license plate information and determine if the relevant license plate information is expired. If the relevant license plate information is not expired, the microprocessor transmits the relevant license plate information to be displayed on the display. If the relevant license plate information is expired, the microprocessor stops the transmission of the relevant license plate information to the display.

It is therefore submitted that the present invention is substantially divergent in design elements from the prior art, and consequently it is clear that there is a need in the art for an improvement to electronic license plates. In this regard, the instant invention substantially fulfills these needs.

### SUMMARY OF THE INVENTION

In view of the foregoing disadvantages inherent in the known types of electronic license plates now present in the prior art, the present invention provides an improved electronic license plate wherein the same can be utilized for allowing a user to electrically display relevant license plate information and deactivating the same when the relevant license plate information is expired.

It is therefore an object of the invention to provide a new and improved electronic license plate that has all of the advantages of the prior art and none of the disadvantages.

Another object of the present invention is to provide a new and improved electronic license plate comprising a housing forming an interior volume configured to support a display assembly.

Yet another object of the present invention is to provide a new and improved electronic license plate, wherein a front face of said housing comprises a digital display configured to be in electric communication with said display assembly.

Still yet another object of the present invention is to provide a new and improved electronic license plate, wherein said display assembly is configured to display relevant license plate information for a vehicle on the digital display.

Another object of the present invention is to provide a new and improved electronic license plate, wherein said display assembly includes a microprocessor having an input module and a activating module.

A further object of the present invention is to provide a new and improved electronic license plate, wherein the input module is configured to allow a user to manually input the relevant license plate information.

Yet a further object of the present invention is to provide a new and improved electronic license plate, wherein the activating module is configured to process said relevant license plate information and determine if the relevant license plate information is expired.

An additional object of the present invention is to provide a new and improved electronic license plate, wherein the microprocessor is configured to deactivate the display if the relevant license plate information is expired.

Still yet another object of the present invention is to provide a new and improved electronic license plate wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective of the present invention.

FIG. 2 shows a schematic diagram of the present invention.

### DETAILED DESCRIPTION OF THE INVENTION

Reference is made herein to the attached drawings. Like reference numerals are used throughout the drawings to depict like or similar elements of the electronic license plate. For the purposes of presenting a brief and clear description of the present invention, the preferred embodiment will be discussed as used for displaying relevant license plate information and deactivating a display when the relevant license plate information is expired. The figures are intended for representative purposes only and should not be considered to be limiting in any respect.

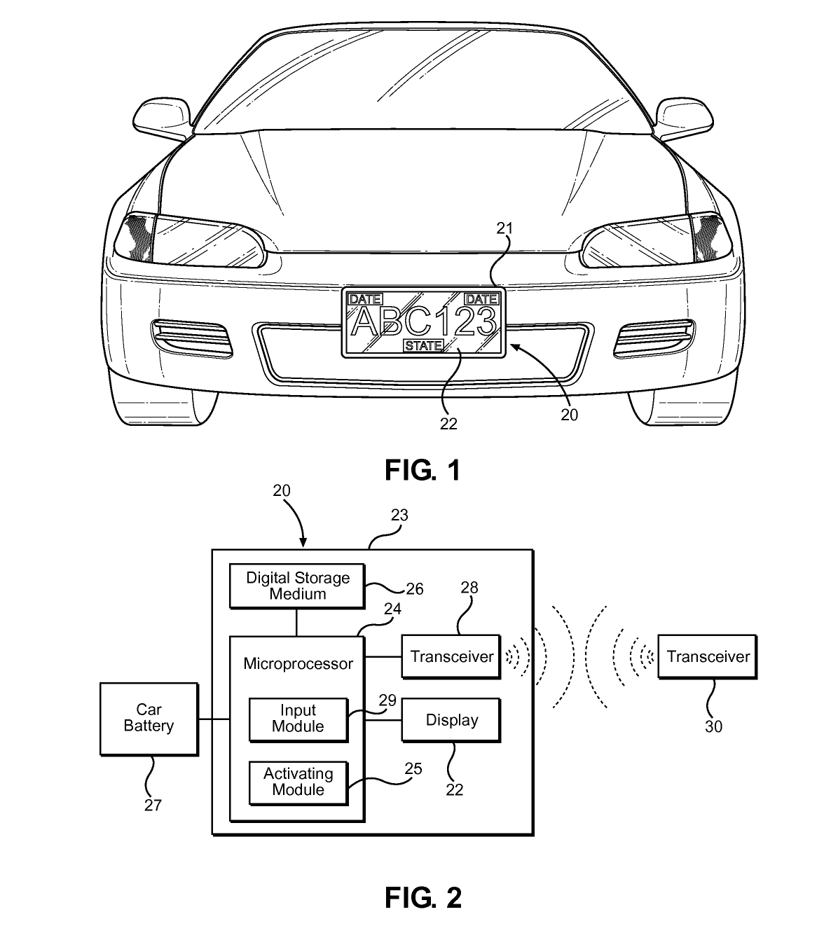

Referring now to FIG. 1, there is shown a front perspective of the electronic license plate 20. The electronic license plate 20 includes a housing 21 that is in a generally rectangular shape forming an interior volume. The housing 21 includes a front face comprising a digital display 22 that is in electric communication with a display assembly. The display assembly is configured to allow a user to manually input relevant license plate information and display the relevant license plate information for a vehicle on the display 22 of the front face. This information includes, but is not limited to, a license plate number, a state of issue, and a registration expiration date. Furthermore, the digital assembly is configured to fully deactivate the display 22, when the registration expiration date is expired. In some embodiments, the digital assembly is configured to display a suspended status or an expired status when the relevant license plate information is expired. In this way, the user becomes aware that the registration for the vehicle needs to be renewed.

Preferably, the housing is in a generally rectangular shape, however, other shapes and sizes that achieve the advantages described herein are suitable, and likewise contemplated within this present disclosure. Furthermore, the housing is preferably composed from a thermoplastic or thermoset material, however, other suitable material are alternatively used in other embodiments of the electronic license plate 20.

Referring now to FIG. 2, there is shown a schematic diagram of the electronic license plate 20. The electronic license plate 20 includes a display assembly 23 that allows a user to manually input relevant license plate information and display it on the display 22. The display assembly 23 includes a microprocessor 24 having an input module 29. The input module 29 allows the user to manually input relevant license plate information and store the relevant license plate information within a digital storage medium 26. In some embodiments, the display 22 is touchscreen and the user can manually input relevant license information through the touchscreen display via the input module. The display assembly 23 in other embodiments are in wireless communication with mobile devices, which allow the user to input relevant license plate information via the input module.

The microprocessor 24 further includes an activating module 25 that is in electric communication with the digital storage medium 26 and is configured to retrieve the relevant license plate information to be processed. The activating module 25 is configured to process the relevant license plate information and transmit the relevant license plate information to be displayed on the digital display 22 via an information signal. The activating module 25 further is configured to determine if the registration expiration date has expired. In these situations, the microprocessor 24 stops the transmission of the information signal and the digital display 22 does not display any relevant license information. The activating module 25 is configured to keep track of the current date and compare the current date with the registration expiration date. In this way, the activating module is configured to determine if the current date is before the registration expiration date, wherein the relevant license plate information will be displayed. If the current date is after the registration expiration date, then the activating module 25 is configured to deactivate the digital display 22 so that the relevant license plate information is not displayed thereon.

In some embodiments, the microprocessor 24 is configured to transmit a suspended status or an expired status to be displayed on said digital display 22 when the relevant license plate information is expired or suspended, respectively, via a digital signal. This is particularly advantageous as the user will immediately recognize that his registration expiration date has expired, and needs to be renewed in order to avoid a ticket from the police.

The display assembly 23 is configured to be electrically connected to a car battery 27 or the vehicle's electrical system that allows the display assembly 23 to be automatically activated when a vehicle is activated. In some embodiments, the display assembly 23 includes an additional battery that provides voltage to power the display assembly 23. Other embodiments also include a plurality of solar panels that are electrically connected to the display assembly 23 in order to provide voltage to power the display assembly 23.

The display assembly 23 also includes a transceiver 28 that is configured to transmit global positioning system (GPS) tracking information. The transceiver 28 is in wireless communication with a second transceiver 30 that can be stored in a safe location by the user and retrieved when the vehicle is missing. In some embodiments, when the microprocessor 24 stops the transmission of the information signal, the microprocessor 24 is also configured to transmit a digital signal to the transceiver 28 to transmit a wireless signal to the second transceiver 30 that is in the hands of the local authorities. The local authorities can then track these users having expired registration license tags.

The digital display 22 can be implemented by a variety of technologies, well known to those skilled in the art, such as an array of light emitting diodes (LEDs), an electroluminescent panel, or preferably, a liquid crystal display (LCD) panel. Preferably, the LCD panel employs an ultraviolet screen on the front to prevent degradation of the digital display 22 in sunlight, in a manner well known to those skill in the art.

Furthermore, the digital storage medium 26 is preferably Random Access Memory (RAM), or a hard drive, however, other suitable alternatives are used in other embodiments, and likewise contemplated in the present disclosure. In addition, while the display assembly 23 described is used for controlling the functionality of the display assembly, alternatives and equivalents including, but not limited to, other types of controller, software, hardware and/or firmware may be suitable. These variations, modifications, and alterations are deemed within the spirit and scope of the present disclosure, and thus contemplated within this present disclosure.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electronic license plate, comprising:
a digital display in electric communication with a display assembly;
said display assembly configured to display relevant license plate information for a vehicle on said digital display;
said display assembly comprising a microprocessor having an input module and an activating module;
wherein relevant license plate information is adapted to be entered via said input module;
wherein said activating module is configured to process said relevant license plate information and determine if said relevant license plate information is expired;
wherein said microprocessor is configured to only transmit said relevant license plate information to be displayed on said digital display via information signal if said relevant license plate information is not expired.

2. The electronic license plate of claim 1, wherein said microprocessor is configured to transmit a suspended status via digital signal if said relevant license plate information is suspended.

3. The electronic license plate of claim 1, wherein said microprocessor is configured to transmit an expired status via digital signal if said relevant license plate information is expired.

4. The electronic license plate of claim 1, wherein said display is adapted to indicate whether said relevant license plate information is expired.

5. The electronic license plate of claim 1, wherein said display assembly includes a digital storage medium configured to store said relevant license plate information therein.

6. The electronic license plate of claim 1, wherein said display assembly is adapted to be electrically connected to a car battery that is configured to provide said display assembly with voltage to electrically power said display assembly.

7. The electronic license plate of claim 1, wherein said display assembly further comprises a transceiver configured to transmit global positioning system tracking information to a second transceiver, thereby allowing a user to track a missing vehicle.

8. The electronic license plate of claim 1, wherein said relevant license plate information includes a license plate number, a state of issue, and a registration expiration date.
